(19) United States
(12) Patent Application Publication
(10) Pub. No.: US 2026/0044223 A1
(43) Pub. Date: Feb. 12, 2026

(54) MOUSE TRACKPAD WITH HAPTICS

(71) Applicant: AZOTEQ HOLDINGS LIMITED, Nicosia (CY)

(72) Inventors: Frederick Johannes BRUWER, Paarl (ZA); Jean VILJOEN, Paarl (ZA)

(21) Appl. No.: 19/294,476

(22) Filed: Aug. 8, 2025

(30) Foreign Application Priority Data
Aug. 8, 2024 (ZA) 2024/06091

(51) Int. Cl. G06F 3/0354; G06F 3/01; G06F 3/044

(52) U.S. Cl. CPC G06F 3/03547; G06F 3/016; G06F 3/044; G06F 2203/04105; G06F 2203/04108

(57) ABSTRACT

A device for emulating functions of a computer mouse which includes a trackpad over which a finger is movable, sensors which produce signals in response to such finger movement and a processor which uses the signals to control cursor movement on a computer screen.

### CROSS-REFERENCE TO RELATED APPLICATION

The present application claims priority from South Africa application ZA 2024/06091, filed Aug. 8, 2024, contents of which is hereby incorporated by reference into this application.

### BACKGROUND OF THE INVENTION

A typical computer mouse product uses a central wheel mechanism for scrolling. The wheel, which requires physical rotation, is mounted to a housing which has one or more openings to enable correct functioning of the product. These openings unfortunately allow for the ingress of liquid or other foreign material to enter the housing—an occurrence which can adversely affect performance.

### SUMMARY OF THE INVENTION

In accordance with the invention a trackpad is used to replace or emulate the function of the centre scroll wheel on a typical mouse product. The invention does however allow for extra features to be offered. Moreover, the invention allows for a form factor which is flatter and more ergonomical.

Normal scrolling achieved by rotating the centre scroll wheel is achieved in the invention by a drag or swipe function or movement forwards or backwards on the trackpad.

In one embodiment of the invention the trackpad is installed on or in a housing e.g. in a top part of the housing which may be similar to a typical computer mouse housing. The trackpad forms a user interface which is similar to that provided by a standard centre mouse wheel.

The trackpad may include force or pressure sensors positioned at opposed ends of the trackpad. These sensors are used to determine at least one of the following functions: single pressure points, or gestures such as moving an object, typically a user's digit (finger) that is touching the trackpad from one end to an opposing end of the trackpad.

The scrolling speed of the centre mouse wheel is related, in this invention, to speed of movement of an object over the trackpad.

A freewheeling function of a conventional mouse can be implemented on the trackpad based on a forwards or backwards flick motion over the trackpad. For example, if a finger is moved forward with a flicking action or motion and the speed of movement is still high when the finger is moved out of touch with the trackpad, then the scrolling replication can continue as if a centre wheel had been spun and had been kept spinning for some time.

Scroll behaviour in this invention is generated through a software algorithm executed by an interface processor. The behaviour is not linked to mechanical behaviour as is the case with a conventional mouse wheel.

The trackpad may be constructed using capacitive sensing, force or pressure sensing, or a combination of capacitive sensing and force or pressure sensing may be used.

If only capacitive sensing is used then the speed and direction of a flick or swipe of an object (a finger), as detected by the trackpad, are used to initiate a freewheeling function. If only force or pressure sensing is used then the speed of a swipe or flick may for example be derived from the rate of change of the force or the pressure as observed by the sensors. These sensors may produce signals which are directly dependent on the force or pressure which is exerted on them. The direction of change of a signal produced by a sensor is indicative of the direction of a flick or swipe of an object on the trackpad. The level of pressure sensed, the direction of pressure change or both may be further analysed to initiate a freewheeling function.

In one embodiment of the invention both methods (capacitive and pressure sensing) are used in combination. It has been found that the robustness of the freewheeling function is thereby improved.

Signals from the capacitive sensors and the force or pressure sensors may be compared to predetermined thresholds respectively before executing a freewheeling function. The thresholds may be adjusted in software executed by the interface processor to facilitate ease of use of the freewheeling function while also avoiding false triggers. The force or pressure sensors can be of various types e.g. capacitive, piezo, strain gauges, or inductive sensors.

In the aforementioned combination the capacitive sensing may be used to track the speed of movement of a digit (finger) over the trackpad in a forwards or backwards direction or even a sidewise movement. The force sensors however are useful in implementing additional user interface functions.

In this specification “force” and “pressure” are used interchangeably.

In one embodiment the force sensors are used to detect a force, applied by a user, that is above a predetermined level, to a location at a front end of the trackpad, at a middle location of the trackpad or at a location at a rear end or back end of the trackpad. Information from that detection may be used to implement predesignated functions, for example a press in the middle may replicate a function which is selected when a standard scroll wheel is pressed downwards.

Movement of an object across the trackpad may be translated into corresponding cursor movement on a computer screen. A central processing unit (CPU) in the computer controls such cursor movement in response to a signal from the interface processor. The trackpad may further include a haptic actuator that provides user feedback in relation to this movement.

Instead of implementing a freewheeling action with a flick gesture, a movement of a finger in a direction across a surface of the trackpad, followed by the application of pressure on the trackpad without removing the finger from the trackpad, may implement continuous scrolling. This may for example be at an average speed or at the highest speed of finger movement before the finger pressure is released.

Continuous scrolling may be effected at a speed which is determined by the distance which is travelled by a finger on the trackpad up to a point at which the finger is either lifted from the trackpad, or stationary pressure is applied to the trackpad. In the latter case for example a short swipe and hold action can trigger a certain scroll speed whereas a longer swipe and hold triggers a higher or faster scroll speed.

The application of a predetermined level of pressure on a front or back end of the trackpad may be interpreted as a respective specific predesignated user interface function. Similarly sideways gestures on a capacitive trackpad may be recognised as specific functions or intentions, for example similar to that achieved by a scroll wheel being pushed sideways.

The trackpad may be elongate with a first sensor at one end, and a second sensor at an opposed end.

If only two force sensors are used, respectively positioned at opposed ends of the trackpad e.g. the front and back end of the trackpad, then sideways force sensing functions are not possible. However, scrolling up and down, or continuous scrolling are feasible, together with middle-, front- and back-end click functions.

If four force sensors are used it is then possible to discern sideways functions or gestures using force sensing only.

With force sensors objects such as user gloves or liquids do not impact performance of the trackpad arrangement, but multiple touch functions are not possible.

Functions like pinch and zoom can be implemented on the device of the invention using the capacitive sensing trackpad.

In a further embodiment haptics are used to announce user interface functions. For example, when dragging a digit from the front to the back over the trackpad, emulating a center mouse wheel being turned backwards, haptics may be used to provide a clicking effect per cursor movement in a manner which is similar to the ratchet effect of a scroll wheel.

The haptic sensation can be varied, based on the scrolling effect and/or direction. The slow movement will have a first tactile sensation, whilst continuous scrolling will have a different tactile sensation. Similarly, a forward scroll sensation may be different to a backward scroll sensation.

The freewheeling effect may be implemented using different algorithms. For example, freewheeling can fade out, similarly to the performance of a heavy scroll wheel, or the speed of freewheeling may linearly reduce over time. Thus the haptic effects may be adapted to tangibly denote the reduction of scroll speed, in a similar manner to the way in which a ratcheting effect of a heavy scroll wheel would. Alternatively, scrolling can continue at a fixed speed until a user stops it.

The scroll algorithm (behaviour) can be implemented by one or more elements of a human interface which includes the interface processor device. Thus the behaviour:
can be a predetermined function programmed into the trackpad mouse (or other input device);
may be adjustable through a user interface dialog box, similar to an operating system's control panel. In this way, a user can select a preferred scroll and haptic behaviour;
may be linked to a specific software application in use, i.e. a scroll event will behave differently for a word processor compared to a computer aided design (CAD) design environment or to a web browser environment; or
can be determined though machine learning, using inputs from a specific user, the user's behaviour and the application in use.

If freewheeling is implemented using a flick gesture, then in an embodiment the freewheeling can be stopped upon a next touch or force sensing event or both. If freewheeling is implemented using a forward movement over the trackpad and a continuous force is applied to the trackpad without any removal of touch then the freewheeling can be terminated when the force is released.

In a further embodiment the force (or pressure) level can be used to adjust the scrolling speed. So, for example, a higher pressure may be used to speed up the scrolling. The distance that a digit (finger) travels on the trackpad, may also be used to determine an initial scroll speed.

Thus, a trackpad can offer the same functions, as a centre mouse wheel, in a more ergonomical and solid state form factor. Additional functions are also offered. A trackpad arrangement also allows for a lower profile housing, compared to conventional wheel assemblies. A low profile mouse may be preferred by certain demographics, to achieve a specific industrial design objective or for the convenience of travel. The use of haptics will make the user experience very similar to the experience of a ratchet type centre wheel.

The force sensors can be of various types (capacitive, piezo, strain gauges) but it is specifically proposed that inductive force sensors are considered due to their robustness against external effects and cost effectiveness.

Force behaviour and force position can trigger predetermined, programmable functions. For example, in one case, a front “press” is used for infinite scrolling, whereas in another case, the front press is used for “Page Up/Page Down”. The behaviour can be determined by one or more elements of a human interface device and/or the electronic device being controlled, as described hereinbefore.

The invention also provides a method to form a user interface to emulate a function of a centre mouse wheel wherein the method includes the steps of determining forward or backward finger movement over a capacitive trackpad mounted in a housing, using said determination to control cursor movement on a computer screen, and using haptics to provide user feedback in relation to said movement determination.

Also provided is a method to form a user interface to perform a function similar to that of a centre mouse wheel, wherein the method include the step of using force sensors mounted to a trackpad in a housing to determine forward or backward finger movement on a surface of the trackpad, using said determination to control cursor movement on a computer screen, and using haptics to provide user feedback in relation to said movement determination.

The position of a finger which applies force to the trackpad may be derived by calculating the force distribution of the force between two or more force sensors.

The trackpad may be mounted to a fulcrum which is positioned between the force sensors, in which case one force sensor's data will increase under force applied and on the opposite side of the fulcrum, the data will decrease. Either sensor may be used to determine if a force is being applied.

Alternatively, both sensors' signals are used in a differential configuration to gain extra resolution in detecting the position of a finger on the trackpad. Sideways gestures can be more easily handled if the trackpad also offers capacitive sensing but a force sensing only solution may be more cost effective.

Haptics may be implemented using Linear Resonant Actuators (LRA's), piezo, solenoid or other technologies.

The invention may be implemented in a device wherein the trackpad is mounted in or to the housing in a sealed manner, and it may present a flat or a curved surface. The trackpad “mouse” may also be equipped with a tactile switch, touch sensor and/or force sensor at a separate location, away from the touch pad, such that the switch or sensor may be activated with a thumb, or a finger not normally used for a scroll wheel. Pressing this remote “switch” allows for preconfigurable gestures that would normally require a two hand operation. For example the classic “zoom” function on a computer screen is achieved by holding down “CTRL” on a keyboard with one hand and rolling the mouse wheel with the other hand. In this embodiment of the invention, only one hand is needed to achieve a similar function. Thus the thumb can press a button of the remote switch whilst the middle finger performs the scroll. The classic “zoom” function is then achieved with a single hand.

### BRIEF DESCRIPTION OF THE DRAWINGS

The invention is further described by way of example with reference to the accompanying drawings in which:

FIG. 1 shows a top side of a trackpad which uses computer trackpads (as per state of the art products) for capacitive sensing and which forms a part of a device according to the invention,

FIG. 2 shows a bottom side of the trackpad with electronic circuitry and an LRA haptics actuator,

FIG. 3 is a side view of a mounted trackpad with two force sensors, one at the front end and one at the back or rear end of the trackpad,

FIG. 4 shows a device according to the invention comprising the trackpad mounted to a mouse-type housing, and

FIG. 5 shows a device according to the invention connected to a computer.

### DESCRIPTION OF PREFERRED EMBODIMENTS

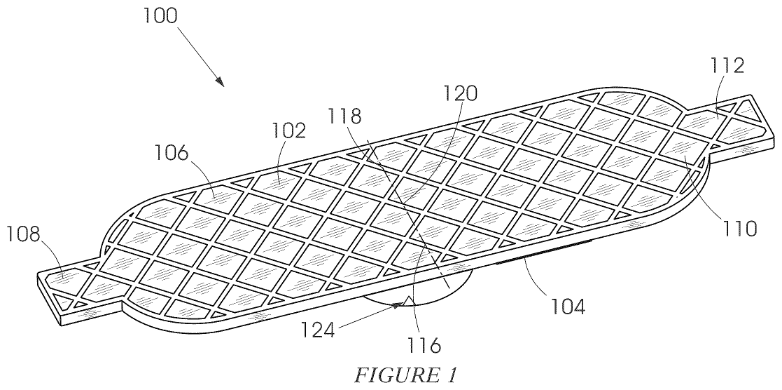

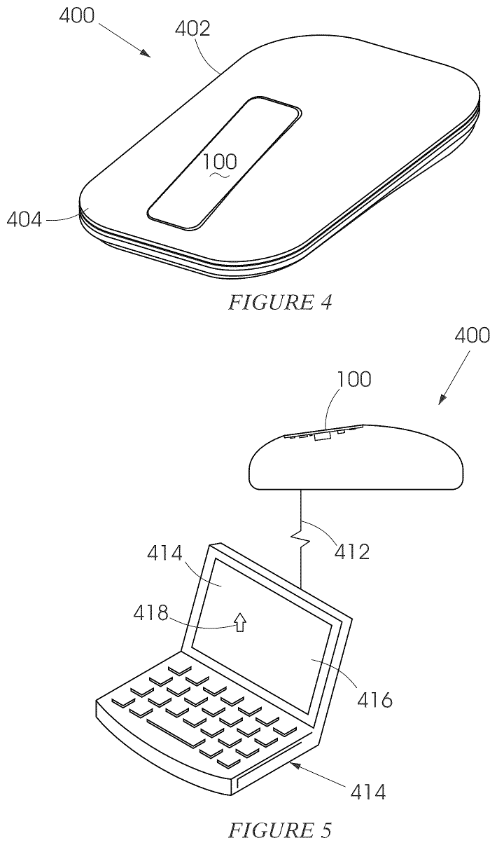

FIG. 1 shows a trackpad 100 with a portion of capacitive sensing electrodes 102 formed on a printed circuit board (pcb) 104. This is similar to what is used on a normal state of the art computer trackpad. The trackpad 100 is inserted into a housing which is similar to a housing of a conventional computer mouse (not shown but further described in connection with FIG. 4 and FIG. 5) where a scroll wheel of the mouse is normally located. A position 106 on the trackpad is at a front end 108 of the mouse housing and a position 110 on the trackpad is at a rear or back end 112 of the mouse housing. The trackpad is included in a device, of suitable shape and size, as shown in FIG. 4.

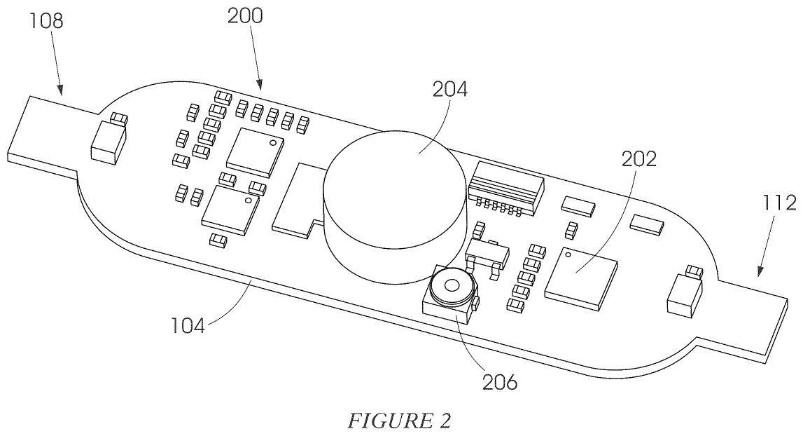

When a user moves a finger from the position 110 in a direction towards the position 106 the detected movement is translated by an interface processor 202 (see FIG. 2), on the rear side of the pcb 104, into movement of a cursor on a computer screen in a manner similar to that which results when the scroll or centre wheel of a conventional computer mouse is rotated in a forwards direction—see FIG. 5. The movements can also be directly related to the speed of finger movement.

If the user performs a sideways gesture, say from a position 116 towards a position 118 as is shown by a short-striped line 120 then the user interface processor 202 interprets this as a command for example (but not limited) to a centre scroll wheel being pushed sideways.

Normal scrolling operation produced by the use of a conventional mouse is achieved with the trackpad 100 by means of a finger dragging movement across a length of the surface of the trackpad 100. Movement of a cursor on the screen (as referred to) is similarly effected. However at the end of the motion the speed of finger movement is slow, particularly at a point where the finger loses contact with the trackpad. Thus, after losing contact, the cursor would be stationary similar to the operation which is achieved with a normal centre mouse wheel.

Two important potential gestures are as follows:
In a first gesture a user moves a finger in a chosen direction at a chosen speed. The finger loses touch or contact with the trackpad while moving faster than a predetermined speed. The user interface processor 202 then determines this to be an action similar to spinning a wheel (of a conventional mouse) such that the motion continues for example at the speed prevailing at the time of lift off. The speed can also be standardised and the fading out may be controlled according to a chosen algorithm implemented by the processor 202. Alternatively the speed can be maintained until stopped by a user command, implemented again via the interface processor.
In a second gesture the user moves a finger over the trackpad and stops but maintains a minimum level of pressure or force at either at the position of the front end 108 or at the position at the back end 112 of the trackpad. The user interface processor 202 then maintains the average speed of motion of the specific gesture movement until the finger is lifted off the trackpad. The speed of scrolling can also be increased or decreased by varying the applied force or pressure to the trackpad.

Both gestures can be implemented using only capacitive sensing. However, if force sensing is added then the decisions can be made with more accuracy especially when the force level is important. It is also possible though to implement a force sensing only solution.

In a further embodiment a typical pinch or zoom gesture can be performed using the mouse trackpad.

FIG. 2 shows a rear side of the trackpad. Electronic components 200 are mounted to the pcb 104. These components include an integrated circuit which functions as the interface processor 202 and which performs the capacitive sensing, and a linear resonant actuator (LRA) 204 which provides haptic actuation. The other components which are necessary to interface with the rest of the device of the invention are mounted to the rear side. These components may for example include a buzzer 206 to provide user feedback.

As shown in FIG. 1 the pcb 104 may be mounted to a centrally positioned fulcrum 124, notionally shown by an icon. The arrangement is then one in which an output signal or data of a sensor on one side of the fulcrum will increase, under the application of force, but on the opposing side of the fulcrum 124 the output signal or data of a sensor on that side will decrease.

Through the use of haptics a user can experience a sensation that is very similar to that which results when a centre scroll wheel of a conventional mouse with a ratchet is operated. This is very useful particularly to indicate when a scrolling, freewheeling, zooming or push button type function selection is performed.

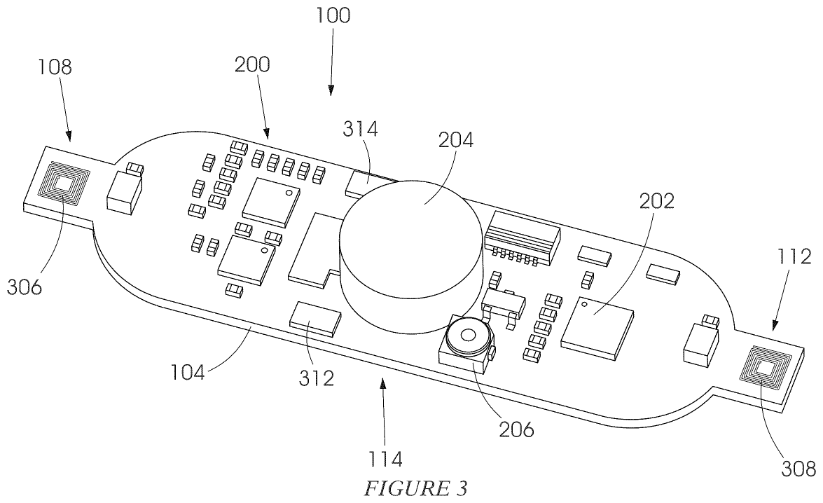

FIG. 3 shows inductive coils 306 and 308 which are at opposed ends of the trackpad 100 which is mounted to a housing of the device of the invention in such a way that when downwards pressure is applied to the trackpad it moves slightly in the direction of the pressure. By using information from the coils, which function as force sensors, it is possible to determine individual points of pressure anywhere on the trackpad. The user interface processor 202 can be programmed to recognise commands resulting from, for example, the application of pressure in excess of a predetermined level being applied to the front end 108, a middle part 114 or the back end 112 of the trackpad. It is also possible to detect and discern swiping or dragging gestures in a forward direction or backwards direction, and also the speed and distance of such gestures. The level of pressure can be measured.

The trackpad may include additional force sensors 312, 314 disposed on opposing long sides of the back of the trackpad thereby to discern sideways gestures or functions using force sensors only. The force sensors, used with capacitive sensory structure facilitate implementation of a freewheeling function.

FIG. 4 shows a device 400 according to the invention wherein the trackpad 100 mounted is mounted an upper part 402 of a housing 404 which has a flat form factor. The trackpad can present a flat or curved surface, to a user, according to ergonomic requirements and can have a sealed fit.

FIG. 5 shows the device 400 according to the invention from one side with a connection 412 which is wireless or wired, to a computer 414 with a screen 416.

The CPU of the computer 414, responsive to the signals from the interface processor 202 in the device of the invention, acts in a manner similar to that which prevails when a conventional mouse is used, to control measurement of a cursor 418 on the screen 416.

The device of the invention is robust, has no moving parts and can be implemented in a manner which provides a seal against the ingress of foreign material.

1. A device for emulating functions of a computer mouse, the device comprising a housing and a trackpad which is mounted to the housing, the trackpad comprising a printed circuit board (pcb) with a first end and a second end, at least first and second sensors, wherein the first sensor is located at the first end of the pcb and the second sensor is located at the second end of the pcb, the first sensor producing a first signal, in response to force applied by an object to the trackpad or to movement of an object over the trackpad, the second sensor producing a second signal in response to a force applied by an object to the trackpad or to movement of an object over the trackpad, and an interface processor for processing said first and second signals to determine at least one of the following functions: at least one pressure point on the trackpad, and movement over the trackpad of an object touching the trackpad.

2. The device of claim 1 wherein the interface processor is configured to implement at least one of the following functions: translation of said movement over the trackpad into corresponding movement of a cursor on a computer screen, a freewheeling function based on at least one of the following: the speed of movement when the object loses contact with the trackpad, and the speed of movement prior to the object being brought to a halt but remaining in force-exerting contact with the trackpad, the device including a haptic actuator to provide user feedback in relation to said movement.

3. The device of claim 2 which includes a fulcrum to which the pcb is mounted and wherein said first and second signals are used in a differential manner to gain better resolution in the determination of emulated functions.

4. The device of claim 1 wherein the interface processor is configured to implement a scrolling action which is dependent on the degree of pressure exerted on the trackpad by said object.

5. The device of claim 1 wherein the trackpad includes capacitive trackpad electrodes which produce a third signal which is dependent on movement of an object across the trackpad surface transverse to a line between the first end and the second end, and wherein the interface processor, responsive to said third signal, controls cursor movement on a computer screen.

6. A device for emulating functions of a computer mouse, which device comprises a housing, a trackpad mounted to the housing, a capacitive sensor pattern on an upper side of the trackpad and an interface processor, responsive to output signals of the capacitive sensor pattern produced by movement of an object over the pattern, to determine at least one of the following: a single touch point on the trackpad, movement of the object touching the trackpad across a surface of the trackpad; and control of cursor movement on a computer screen.

7. A method of emulating functions of a centre wheel of a computer mouse wherein the method includes the steps of determining forward or backward movement of a finger over a capacitive trackpad which is mounted to a housing, translating said movement into corresponding movement of a cursor on a computer screen and using haptics to provide user feedback in relation to said movement determination.

8. The method of claim 7 which includes the step of using a capacitive sensing structure mounted to the trackpad to determine at least one of the following; said forward and backward finger movement across the trackpad; a zoom or a pinch function on a computer screen.

9. The method of claim 7 which includes the step of using a capacitive sensing structure mounted to the trackpad and a force sensing structure mounted to the trackpad to emulate a freewheeling function of said centre wheel.

10. A method of emulating functions of a centre wheel of a computer mouse, wherein the method includes the steps of determining forward or backward finger movement over a trackpad using force sensors mounted to the trackpad, translating said movement into corresponding cursor movement of a cursor on a computer screen and using haptics to provide user feedback in relation to said movement determination, or to touch actions.
